(19) United States
(12) Patent Application Publication
(10) Pub. No.: US 2006/0016416 A1
(43) Pub. Date: Jan. 26, 2006

(54) Polymeric manifold assembly and method

(75) Inventors: Dukhyung Kim, Incheon (KR); Timothy Keighron, Rochester Hills, MI (US); Jae Myung Rhee, Waterford, MI (US); Randy Stull, Lake Orion, MI (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: R&B, Inc., Colmar, PA (US)

(21) Appl. No.: 11/156,327

(22) Filed: Jun. 17, 2005

Related U.S. Application Data
(60) Provisional application No. 60/581,017, filed on Jun. 18, 2004.

(51) Int. Cl. F02M 35/10

(52) U.S. Cl. 123/184.61

(57) ABSTRACT

A method for manufacturing an engine intake manifold assembly is provided. The method includes forming a top, middle, and bottom section of the manifold assembly in an injection molding process, each including cavities defined with positive draft angles, the cavities defining a plurality of internal passageways in an assembled state of the manifold assembly. The top, middle, and bottom sections are joined to form the manifold assembly through vibration welding or ultrasonic welding. An engine intake manifold assembly having top, middle, and bottom sections joined through vibration welding or ultrasonic welding is also provided.

### CROSS REFERENCE TO RELATED APPLICATION

This application claims the benefit of U.S. Provisional Application No. 60/581,017, filed Jun. 18, 2004, which is incorporated by reference herein as if fully set forth.

### BACKGROUND

The present invention pertains to the field of engine intake manifolds. It is particularly related to methods of forming engine intake manifold assemblies.

In most vehicles built in the last decade, intake manifold assemblies are typically manufactured by a molding process. This has commonly been done by a process known as lost core molding, wherein a desired material is heated to liquid form and placed in a mold around a core. Cores made of high temperature wax or foam are used when the part to be molded has complex internal geometry. When the material has cooled to form the manifold, the core is then removed, for example by heating so that it melts, producing with complex inner passageways inside the manifold that are required to distribute a fuel/air mixture from throttle body fuel injectors or a carburetor to the intake ports in the head(s).

Although this known method produces a manifold assembly in a single molding process, lost core molding is financially unfeasible for smaller manufacturers due to its high expense. In an effort to find a more cost effective method of production, the manifold assemblies have also been formed by molding two separate sections of the manifold out of glass filled plastic, and then joining the two sections with a structural adhesive.

### SUMMARY

In order to produce the intake manifold assemblies in a more cost effective manner, while ensuring that the structural integrity and functional requirements of the manifold are maintained, the present invention employs a method in which three sections of the manifold are separately formed of a polymeric material, for example nylon 6 or nylon 6/6, in an injection molding process. Each section defines portions of the complex internal passageways as open cavities having positive draft angles that can be formed using conventional injection molding techniques. The three sections include complementary interfacing surfaces, which are used in joining the three sections together to form the manifold assemblies so that the cavities are aligned and sealed together to define the internal passageways, preferably through vibration or ultrasonic welding.

### BRIEF DESCRIPTION OF THE DRAWING(S)

FIG. 1 is an isometric view of the assembled engine intake manifold.

FIG. 2 is an exploded, isometric view showing the three sections of the engine intake manifold assembly.

FIG. 3 is an exploded side view showing the three sections of the engine intake manifold assembly.

### DETAILED DESCRIPTION OF THE PREFERRED EMBODIMENT(S)

Certain terminology is used in the following description for convenience only and is not considered limiting. Words such as “front”, “back”, “top” and “bottom” designate directions in the drawings to which reference is made. This terminology includes the words specifically noted above, derivatives thereof and words of similar import. Additionally, the terms “a” and “one” are defined as including one or more of the referenced item unless specifically noted. The phrase “at least one” followed by a list of two or more items (such as A, B, or C) means any individual one of A, B or C as well as any combination thereof.

The preferred embodiments of the present invention are described below with reference to the drawing figures where like numerals represent like elements throughout.

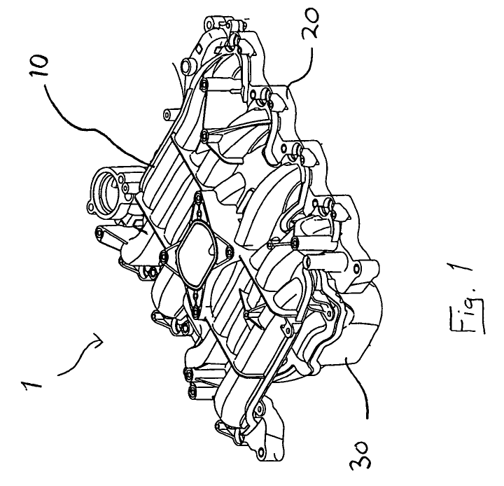

As shown in FIG. 1, an engine intake manifold assembly 1 in accordance with the present invention is shown. The manifold 1 is formed by joining a top section 10, a middle section 20, and a bottom section 30. The manifold assembly 1 includes complex internal passageways for uniformly distributing fuel from a source, such as a carburetor or throttle body fuel injectors, to the intake ports of the head(s). The top section 10, middle section 20, and bottom section 30 are made from a polymeric material. In a preferred embodiment, the top, middle, and bottom sections 10, 20, 30 are made from nylon 6 or nylon 6/6. However, other materials can be used depending on the particular application.

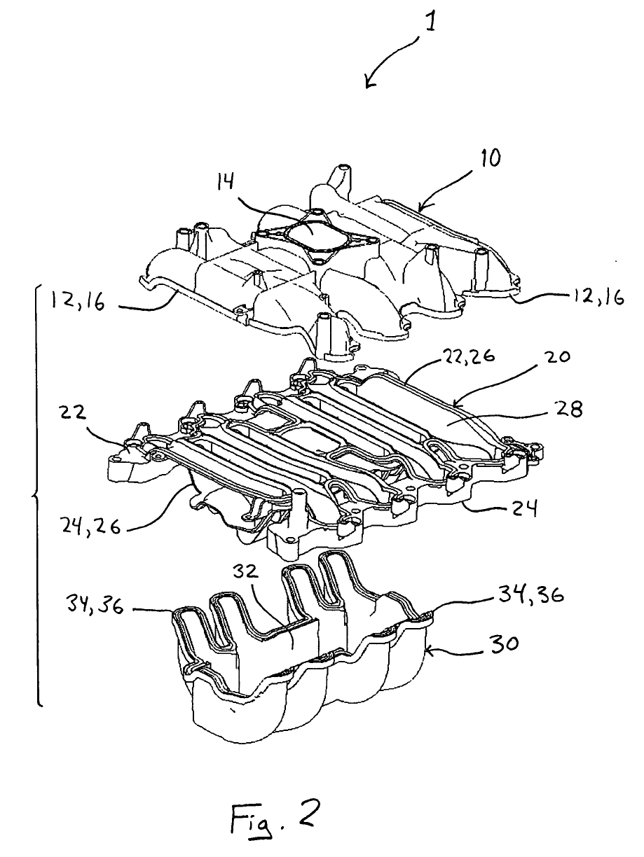

Referring to FIG. 2, the top section 10, middle section 20, and bottom section 30 each have a plurality of cavities 14, 28, and 32, respectively. The cavities are designed as portions of the complex internal manifold passageways and have positive draft angles so that each section can be molded in a conventional injection molding process, preferably with two piece tools. This allows the sections 10, 20, 30 to be freely released from the tool surfaces due to the cavity design.

The cavities 14, 28, 32 on the respective parts have interfacing surfaces 12, 22, 24, and 34 that are complementary to one another, so that upon assembly, the required internal passageways are formed having generally the same geometry of a one-piece manifold manufactured by lost core molding. The surface area at the interfacing surfaces 12, 22, 24, 34 are of a sufficient size for welding and/or fastening, preferably in the range of 0.25 inch (6 mm) or under. The interfacing surfaces 12, 22, 24, and 34 can be held to close tolerances in the molding process so that they can be closely fit and aligned for sealing the respective internal passageways during the welding and/or fastening process.

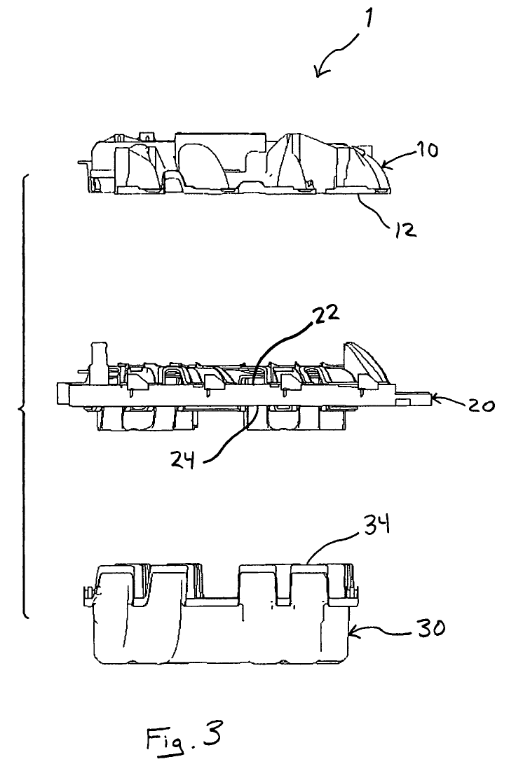

Referring to FIGS. 2 and 3, the top section 10 has a lower mating surface 12. The middle section 20 has an upper mating surface 22 that is complementary to the lower mating surface 12 of the top section 10, and a lower mating surface 24. The bottom section 30 has an upper mating surface 34 that is complementary to the lower mating surface 24 of the middle section 20. These surfaces are preferably flat, or may have protrusions and recesses to assist in alignment and/or welding.

The manifold assembly 1 is formed by joining the lower mating surface 12 of the top section 10 with the upper mating surface 22 of the middle section 20, and by joining the lower mating surface 24 of the middle section 20 with the upper mating surface 34 of the bottom section 30. The sections are joined at the surfaces through either vibration or ultrasonic welding. In a preferred embodiment, weldment tabs 16, 26, 36 can be used to enlarge the surface areas of the mating surfaces 12, 22,24,34 for welding. During vibration welding the plastic at the interfacing surfaces becomes molten and provides a seal when it cools. The vibration or ultrasonic welding is done in accordance with known practices. Accordingly, a further description of the vibration or ultrasonic welding is not provided herein.

In accordance with the invention, a resin, for example a liquid resin can be applied on the mating surfaces to assist in sealing/welding to ensure a uniform and consistent weld and that sealing occurs between the internal passageways that are formed.

As shown in FIG. 1, the manifold 1 thus formed includes the required mounting holes for installation on an engine. Further, the manifold 1 can include molded in inserts at bolt locations as well as stand offs for accessory mounting in the manner of an OEM (original equipment manufacturer) manifold. Overall dimensions of manifold 1 preferably match an OEM manifold or are designed to fit existing OEM applications. The manifold 1 can alternatively include additional reinforcements in known failure areas of a related OEM part. Providing such reinforcements or other modifications is facilitated by the unique three part design of the manifold 1 which allows for more versatile and less costly tooling.

While the preferred embodiments of the invention have been described in detail above, the invention is not limited to the specific embodiments described above, which should be considered as merely exemplary. Further modifications and extensions of the present invention may be developed, and all such modifications are deemed to be within the scope of the present invention as defined by the appended claims.

What is claimed is:

1. A method for manufacturing an engine intake manifold assembly comprising;
separately forming top, middle, and bottom sections of the manifold assembly in an injection molding process, each including cavities defined with positive draft angles, the cavities defining a plurality of internal passageways in an assembled state of the manifold assembly; and
joining the top, middle, and bottom sections to form the manifold assembly through vibration welding or ultrasonic welding.

2. The method of claim 1, further comprising providing nylon for the forming of the top, middle, and bottom sections of the manifold assembly.

3. The method of claim 1, further comprising providing nylon 6/6 for the forming of the top, middle, and bottom sections of the manifold assembly.

4. The method of claim 1, wherein the forming comprises injecting molding a polymeric material into two piece mold tools for each of the sections.

5. The method of claim 1, wherein the forming comprises forming the top, middle, and bottom sections with complementary portions.

6. The method of claim 1, wherein the forming comprises forming weldment tabs on at least one of the top, middle, and bottom sections of the manifold assembly, and the joining comprises joining the weldment tabs on the one of the top, middle, and bottom sections with a corresponding portion of another one of the top, middle, and bottom sections.

7. The method of claim 1, further comprising applying a liquid resin between at least a first mating surface of one of the top, middle, and bottom sections and a corresponding second mating surface of another one of the top, middle, and bottom sections.

8. An engine intake manifold assembly comprising:
a top section (10) having a first plurality of cavities (14) with positive draft angles formed from an injection molded polymeric material;
a middle section (20) having a second plurality of cavities (28) with positive draft angles formed from an injection molded polymeric material; and
a bottom section (30) having a third plurality of cavities (32) with positive draft angles formed from an injection molded polymeric material, the top section (10) has a lower mating surface (12) which is joined to an upper mating surface (22) of the middle section (20) through vibration welding or ultrasonic welding, and the bottom section (30) has an upper mating surface (34) which is joined to a lower mating surface (24) of the middle section (20) through vibration welding or ultrasonic welding so that the first, second, and third plurality of cavities are joined together to form a plurality of separate sealed internal passageways through the intake manifold.

9. The engine intake manifold of claim 8, wherein at least one of the mating surfaces comprises a weldment tab that provides an enlarged area for the at least one of the mating surfaces.

10. The engine intake manifold of claim 8, wherein a resin is disposed between at least a portion of at least two of the mating surfaces.

11. The engine intake manifold of claim 8, wherein at least one of the top, middle and bottom sections is nylon.

12. A method for manufacturing an engine intake manifold assembly comprising;
forming a plurality of sections of the manifold assembly in an injection molding process, each of the sections including cavities defined with positive draft angles, the cavities defining a plurality of internal passageways in an assembled state of the manifold assembly; and
joining the plurality of sections to form the manifold assembly through vibration welding or ultrasonic welding.

13. The method of claim 12, further comprising providing nylon for the forming of the plurality of sections of the manifold assembly.

14. The method of claim 12, further comprising providing nylon 6/6 for the forming of the plurality of sections of the manifold assembly.

15. The method of claim 12, wherein the forming comprises using two piece mold tools to form each of the plurality of sections.

16. The method of claim 12, wherein the forming comprises forming at least one of the plurality of sections with a portion which is complementary to at least another one of the plurality of sections.

17. The method of claim 12, wherein the forming comprises forming weldment tabs on the plurality of sections of the manifold assembly, and the joining comprises joining the weldment tabs on one of the plurality of sections with the weldment tabs on another one of the plurality of sections.

18. The method of claim 12, further comprising applying a liquid resin between at least a first mating surface of one of the plurality of sections and a corresponding second mating surface of another one of the plurality of sections.
